(19) United States
(12) Patent Application Publication
(10) Pub. No.: US 2013/0290171 A1
(43) Pub. Date: Oct. 31, 2013

(54) SYSTEM AND METHOD FOR FORMING, MANAGING AND EXECUTING AN ESCROW AGREEMENT RELATED TO AN EMPLOYMENT CONDITION

(71) Applicants: KENNETH D. WINTERS, SCOTTS VALLEY, CA (US); BRIAN G. TARDELL, SCOTTS VALLEY, CA (US); MELANIE RAE MESIROFF, SCOTTS VALLEY, CA (US); ADAM R. BLANTON, SANTA CRUZ, CA (US); JARED D. BOOYE, CAPITOLA, CA (US)

(72) Inventors: KENNETH D. WINTERS, SCOTTS VALLEY, CA (US); BRIAN G. TARDELL, SCOTTS VALLEY, CA (US); MELANIE RAE MESIROFF, SCOTTS VALLEY, CA (US); ADAM R. BLANTON, SANTA CRUZ, CA (US); JARED D. BOOYE, CAPITOLA, CA (US)

(21) Appl. No.: 13/460,769

(22) Filed: Apr. 30, 2012

(51) Int. Cl. G06Q 40/00; G06Q 10/06

(52) U.S. Cl. 705/39

(57) ABSTRACT

A method and system are provided that enable the negotiation, formation, monitoring, documentation and performance of an escrow agreement related to an employment condition. The escrow agreement may be managed and fulfilled by an escrow service. A first party may offer an agreement to a second party wherein the escrow agreement offers consideration to the second party in return for a performance by a third party related to an employment condition. The first party and second party may negotiate, modify and form the escrow agreement by means of an information technology network, such as the Internet or a telephony network. One or more escrow payments may be delivered to one or more parties while an aspect of employment as stipulated in the escrow agreement is maintained or provided by the third party. The escrow payments may be of varying or different values.

### FIELD OF THE INVENTION

The present invention relates to employee recruitment and retention. More particularly, the present invention relates to systems and methods of engagements, agreements and interaction between employers and other parties supportive of recruiting employees.

### BACKGROUND OF THE INVENTION

The present invention relates to systems and methods for managing and incentivizing participants in employee recruiting. It is a common practice in many industries for firms having job openings to contract with other parties, such as professional recruiters, to find, suggest and encourage suitable candidates for employment. Recruiters and employers often contract for compensation to be earned by the recruiter only by a successful placement of a candidate referred by the recruiter in a job opening with the employer. This reward is usually provided in a single payment to a recruiter whereby the recruiter is financially motivated to focus more on providing candidates who receive and accept job offers and to be less financially motivated to be interested in the duration of the referred and newly employed candidate with a contracting employer

A major advantage of the standard one-time payment arrangement is that recruiters and others due for compensation in finding job candidates is that recruiters and the contributors in the work of referring suitable and selected employment candidates are generally confident of being rewarded as promised by a contracting employer. Any delay in direct payment by an employer to a contractor or other party promised a reward for successfully finding a job candidate may reduce the interest level by recruiters and other potentially helpful parties and be perceived as an introduction of risk in the performance of a promised commission. Yet the highest value of finding and hiring effective employees and is typically realized by an employer after each new hire has been retained for several years. The prior art fails to provide a system of compensation that optimally encourages recruiters and other potentially helpful parties to be committed to the long term employment of placed job candidates with contracting employees while simultaneously building confidence in the successful contributors in candidate searching of being rewarded as promised by hiring firms.

Accordingly, it would be desirable to provide compensation systems and methods for rewarding employee recruitment that address the above disadvantages and other issues made obvious to one or ordinary skill in the art in light of the present disclosure.

### SUMMARY OF THE INVENTION

Toward this and other objects that are made obvious in light of the disclosure, a method and system are provided for structuring and performing an escrow agreement that provides rewards for recruiting employees.

In one aspect of the method of the present invention (hereinafter, “the invented method”) a first party generates an offer of compensation to a second party, wherein the offer includes both (a.) a condition of employment to be provided by a third party that is required to be met for the compensation to be even partially earned; and (b.) stipulates that the at least some of the earned compensation will be provided through an escrow process. The third party may initially be an employment candidate who is referred by a recruiter to a potential employer, wherein the recruiter may be the second party and the potential employer (or “employer”) may be the first party. The employer then funds an escrow by providing an escrow deposit, under the terms and conditions of the escrow agreement, wherein an escrow deposit or control of the escrow deposit is transferred from the employer and to an escrow agent and/or an escrow system. The escrow system may be a computational system as described herein.

Additionally or alternatively, an escrow agent or an escrow system may generate an escrow agreement having one or more terms or conditions that offered by the first party and modified in a negotiation between the first party and the second party prior to a final offer of an escrow agreement having terms and conditions that are accepted by the second party. The escrow agent and/or the escrow system may then execute or enforce the escrow agreement under the final terms offered by the first party and accepted by the second party. Alternatively or additionally, either the first party or the second party may open an escrow account with the escrow agent and/or by means of communication with the escrow system.

In various alternate preferred embodiments of the invented method, the first and second party may negotiate an agreement by authoring and delivering offers and counter offers until an offer or counter offer presented by one party is accepted by the other party. Alternatively or additionally, the first party or the second party may be an employer, a current or past employee or contractor of the employer, a recruiter, a firm, or other natural person or business entity. It is understood that the party who generates a first offer may be (a.) an employer promising compensation for a successful job placement; (b.) an intended beneficiary of the compensation stipulated in the first offer; or (c.) or other party.

In another optional aspect of the invented method, the first party provides an escrow payment to an escrow agent or escrow service (hereinafter collectively “the escrow agent”) and the escrow agent provides one or more escrow payments to the second party in accordance with the stipulations, terms and conditions of an escrow agreement agreed to by the first and second party.

In yet other optional aspects of the invented method, it is understood that in one or more escrow agreements may stipulate that that escrow deposit may be paid out, in accordance with the stipulations, terms and conditions of specific agreements, by the escrow agent (a.) in a single escrow payment; (b.) by a series of substantively equivalent escrow payments; (c.) by a series of escrow payments wherein a single escrow payment is larger than all other payments of that series; (d.) by an ascending series of escrow payments wherein at least some of the payments comprise an ascending order of payment amounts over time; (e.) by a descending series of escrow payments wherein at least some of the payments comprise a descending order of payment amounts over time; (f.) in portions to two or more beneficiaries, e.g., splitting one or more escrow payments among two separate recruiters or other parties; (g.) a series of escrow payments that include one or more balloon payments, wherein at least one balloon payment is a first escrow payment or a final escrow payment; and/or (h.) a series of escrow payments that include one or more balloon payments, wherein at least one balloon payment is made early or late within a series of escrow payments.

In still other optional aspects of the invented method (a.) the escrow deposit and/or one or more payouts from the escrow deposit may be at least partially transferred by automated clearing house transfer, wire transfer, electronic funds transfer, bank check, personal check, cashiers check, postal money order and/or money order; (b.) the amount of the escrow deposit may be at least partially derived from an employment compensation level of the third party accepting employment; (c.) a remaining value held by the escrow agent may be returned to a provider of the escrow deposit, or other stipulated party, upon an interruption or cessation of a condition of the escrow agreement; (d.) an initial escrow payment is dependent upon an employment start or start date of a third party; (e.) a party may generate an invitation or offer to form an escrow agreement wherein optionally the invitation or offer expires if not accepted within a specified time period or upon an occurrence or a lapse of a condition prior to a=an acceptance; and/or (f.) a party tendering an offer may cancel the offer prior to formation of an escrow by an acceptance of the offer.

In even other optional aspects of the invented method one or more information technology networks or systems are adapted, provided and/or targeted to instantiate or enable or one or more aspects of the invented method. Alternatively or additionally, one or more information technology networks or systems (a.) are employed to manage electronic tokens and/or virtual slots that may support creating, identifying and/or tracking of one or more employment conditions related to or stipulated in one or more escrow agreements; (b.) comprise one or more user interfaces that enable formation, tracking and performance of at least one escrow agreement; and/or (c.) are adapted to generate, transmit, receive and/or enable a party to author electronic messages, e.g., offers, counter offers, acceptances, performance notices, contractual breach notices, and/or alerts related to an escrow agreement.

In additional optional aspects of the invented method, one or more information technologies systems are provided that comprise processers and means that enable communication among the first party, the second party, the agent escrow and/or other parties.

### BRIEF DESCRIPTION OF THE FIGURES

FIG. 1 illustrates aspects of a first preferred embodiment of the invented method encompassing actions performed by a first party and events related to the first party;

FIG. 2 illustrates additional aspects of the invented method encompassing actions performed by a second party and events related to the second party regarding the second party receiving an offer to form an escrow agreement;

FIG. 2 illustrates additional aspects of the invented method encompassing actions performed by the second party of FIG. 2 and events related to the second party regarding the second party receiving a counter offer to form an escrow agreement;

FIG. 4 is a flow chart of an automated application of an escrow computer system in the management of the performance of an escrow agreement formed by the process of FIGS. 1 through 3;

FIG. 5 is a schematic of electronics communications network enables the first party and the second party of FIGS. 1 through 4 and the escrow computer system of FIG. 4 to perform aspects of the invented method in whole or in part as disclosed herein by electronic messaging;

FIG. 6 is a schematic diagram of a computer system that may be adapted to serve as a computer system of FIG. 5;

FIG. 7 is a schematic diagram of optional software modules of one or more computers of FIG. 5;

FIG. 8 is a flowchart of a management of a slot escrow process by the escrow computer system of FIGS. 4 through 7;

FIG. 9 is a representation of an escrow agreement record that enables the escrow computer system of FIGS. 4 through 7 to manage and execute an escrow agreement of FIGS. 1 through 3;

FIG. 10 is a process chart that discloses additional optional aspects of the method of the present invention provided within a payment process wherein an individual is identified and an escrow agent or escrow system receives control of an escrow deposit;

FIG. 11 is a representation of an escrow interface input screen that is generated on the display screen of the escrow system or other system of FIG. 5 accessible to an employer, a recruiter, an escrow agent, or other third party;

FIG. 12 is a flow chart of certain optional aspects of the method of the present invention as performed by an escrow agent in concert with the escrow system of FIG. 5;

FIG. 13 is a flow chart of certain other additional aspects of the invented method that may be performed by or by means of the first party system of FIG. 5;

Referring now to FIG. 14, FIG. 14 is a flow chart of still additional optional aspects of the invented method that may be performed in concert by the recruiter with the recruiter system;

Referring now to FIG. 15, FIG. 15 is a flow chart of even additional optional aspects of the invented method that may be performed in concert by the recruiter with the recruiter system;

FIG. 16 is a representation of a token record that enables the escrow computer system of FIGS. 4 through 7 to manage and execute an escrow agreement of FIGS. 1 through 3;

FIG. 17 is a schematic representation of a system memory of FIG. 6 showing the recordation in a first exemplary database of the system memory storing digitized records, including tokens, escrow records, slots and a plurality of escrow documents;

FIG. 18 is a schematic representation of the escrow agreement of FIG. 2 in a state of documenting a contract offered by the employer and accepted by the recruiter;

FIG. 19 is a schematic representation of a plurality of slots of FIG. 17;

FIG. 20 presents a flowchart of other additional aspects of the invented method in application in an outplacement escrow payment process as performed by the employer system of FIG. 5; and

FIG. 21 presents a flowchart of still additional aspects of the invented method in application in an outplacement escrow payment process as performed by the escrow system of FIG. 5.

### DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

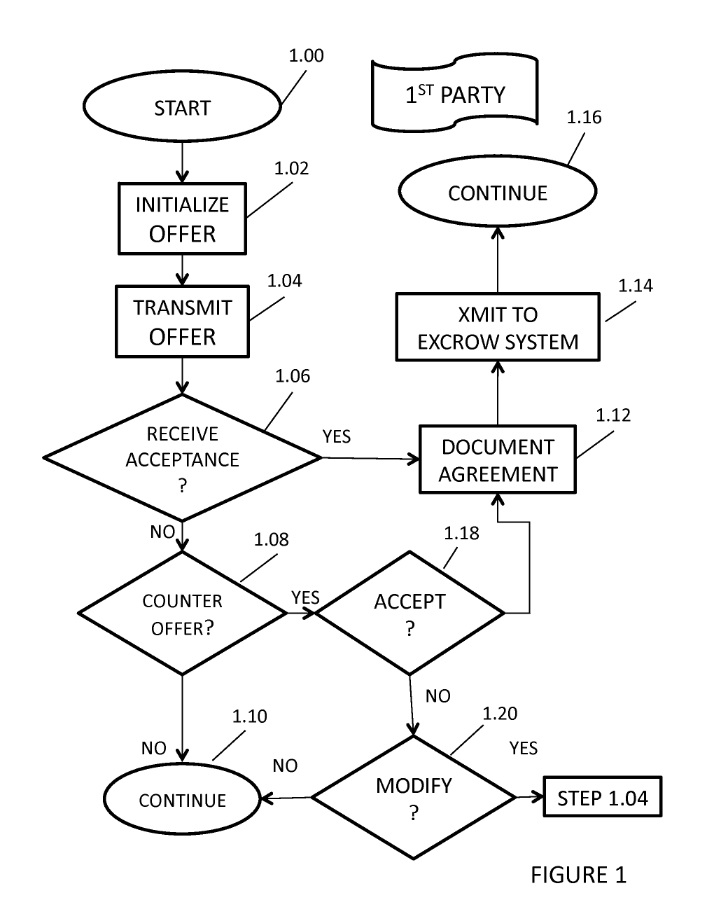

Referring now to FIG. 1, aspects of a first preferred embodiment of the invented method are described by a process chart encompassing actions performed by a first party and events related to the first party. In step 1.02 an offer to form an escrow agreement is initialized and codified by the first party. The offer is then sent or transmitted to a second party in step 1.04 via hard copy and/or electronic messaging. x The first party determines in step 1.06 whether an acceptance to the offer has been received in step 1.06. When the first party determines in step 1.06 that an acceptance of the offer has not been received in step 1.06, the first party proceeds on to step 1.08 and to determine whether a counter offer has been received. If the first party determines that no acceptance or counter offer has been received, the first party proceeds on to alternate activities in step 1.10. It is understood that the first party may cancel or nullify the escrow payment offer prior to acceptance by a second party and prior to transferring either an escrow deposit or control of an escrow deposit to the escrow agent.

Referring now to step 1.06, when the first party determines that a the second party has transmitted or communicated an acceptance of the offer of step 1.04, the first party proceeds on to step 1.12 to document the escrow agreement and to transmit or communicate the agreement to an escrow agent or escrow system in step 1.14. The first party proceeds on from step 1.14 to other activities in step 1.16.

Referring now to step 1.08, when the first party determines that a counter offer has been received, the first determines in step 1.18 whether to accept the counter offer. When the first party elects to accept the counter offer, the first party proceeds from step 1.18 to perform steps 1.12 through 1.16. When the first party determines in step 1.18 to not accept the counter offer, the first party determines in step 1.20 whether to modify the counter offer and to generate a succeeding counter offer. When a succeeding, modified counter offer is generated by the first party in step 1.20, the first party proceeds from step 1.20 to an additional performance of step 1.04. If the first party determines in step 1.20 to not generate a modified counter offer, the first party proceeds on to alternate activities in step 1.10.

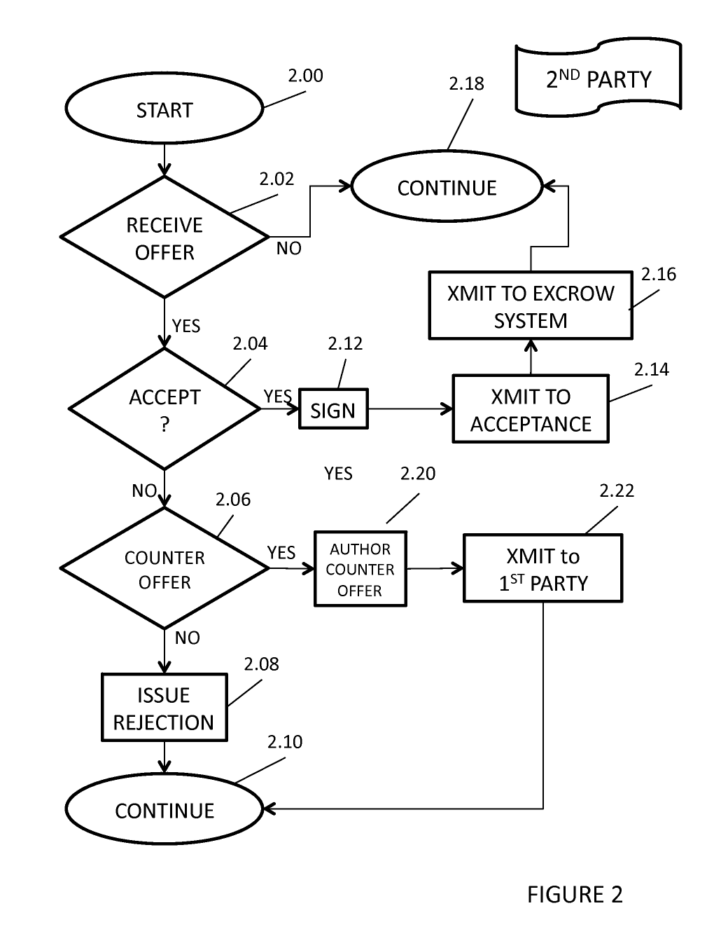

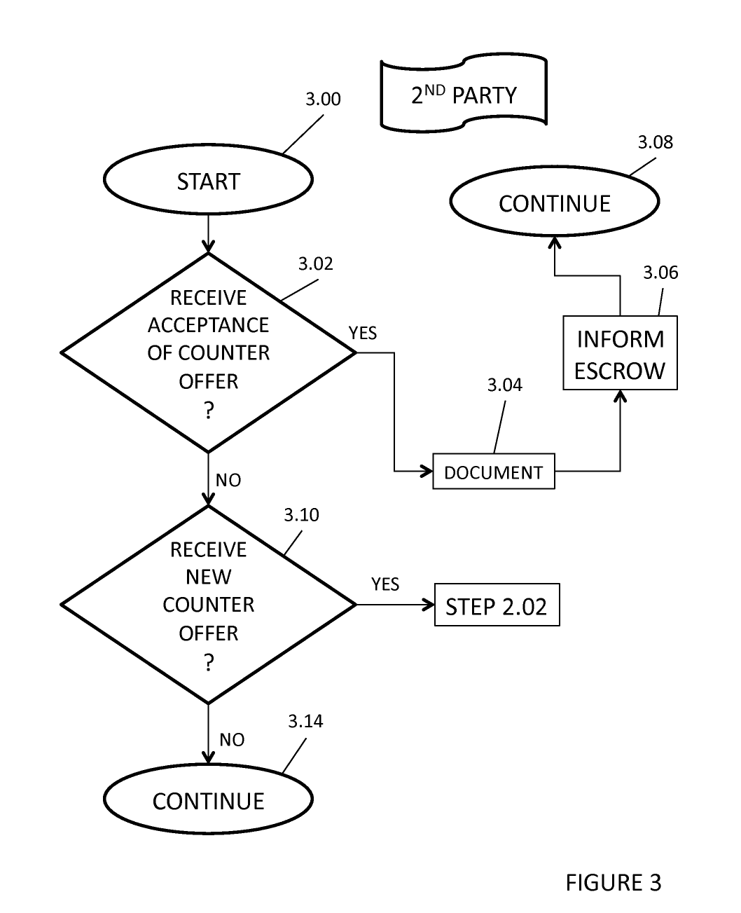

Referring now to FIG. 2, further alternate aspects of the invented method are described by a process chart encompassing actions performed by the second party and events related to the second party. In step 2.02 an offer to form an escrow agreement is received by the second party as communicated in hard copy or transmitted by electronic messaging from or by the first party. The second party determines in step 2.04 whether to accept the received offer in step 2.04 and optionally elects to issue a counter offer in step 2.06 or to issue a rejection of the offer in step 2.08. The second party proceeds from step 2.08 to step 2.10 to perform alternate actions. Alternatively, when the second party elects to accept an offer in step 2.04, the second party accepts the offer by hard copy or electronic signature in step 2.12 and communicates the acceptance to the first party in step 2.14 and to an escrow agent or escrow system in step 2.16. The first party proceeds on from step 2.16 to step 2.18 and to perform alternate actions.

Alternatively, the first party may elect in step 2.06 to generate a counter offer in step 2.20 and to transmit or communicate the counter offer to the first party in step 2.22.

Referring now to FIG. 3, FIG. 3 illustrates additional process steps of the second party to be performed after step 2.22 of FIG. 2. The second party determines in step 3.02 whether the first party has transmitted or communicated an acceptance of a counter off by the first party of step 2.22. When the second party determines in step 3.02 that an acceptance has been received, the second party documents the formation of an escrow agreement in step 3.04 and informs the escrow agent or system in step 3.06 and proceeds on to alternate activities in step 3.08.

When the second party determines in step 3.02 that an acceptance has not been received, the second party proceeds on to step 3.10 and to determine in step 3.10 whether a counter offer has been received. When a receipt of a counter offer is recognized by the second party in step 3.10, the second party proceeds on to an additional execution of step 2.02. When a receipt of a counter offer is not determined by the second party in step 3.10, the second party proceeds on to alternate activities in step 3.14.

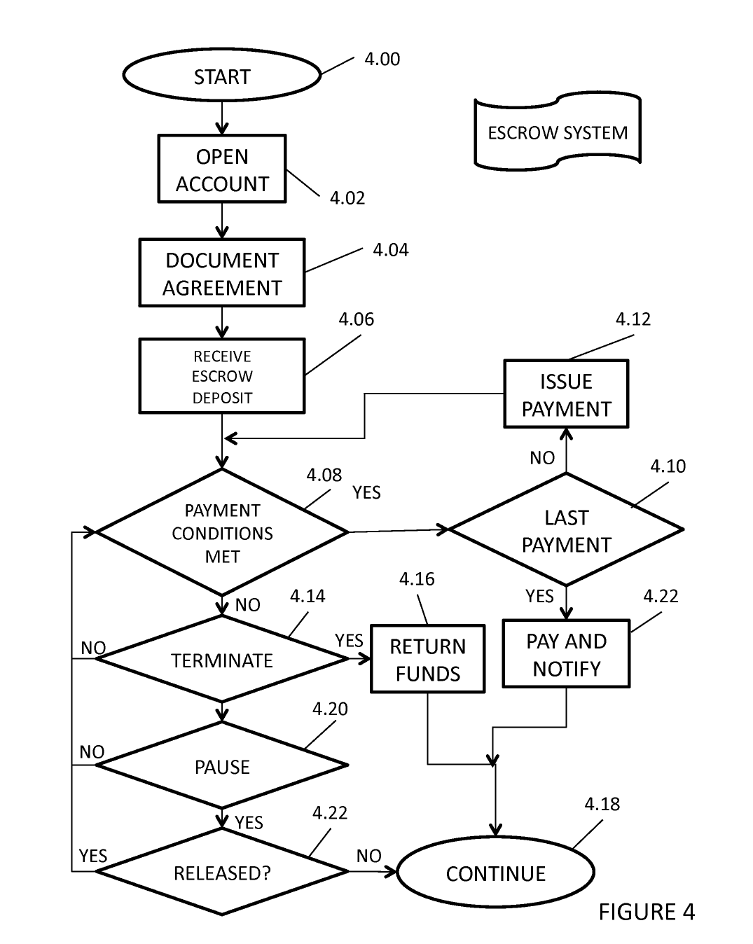

Referring now to FIG. 4, FIG. 4 is a flow chart of an automated application of an escrow computer system 2 (hereinafter “the escrow system” 2) in the management of the performance of an escrow agreement. In step 4.02 the escrow system 2 initiates an escrow account and receives an electronic escrow agreement document MSG 3 (hereinafter, “escrow agreement” MSG 3) that is or comprises a governing escrow agreement in step 4.04 and receives an escrow deposit notification in step 4.06.

It is understood that the may employer system 6 may cancel or nullify the escrow payment offer prior to acceptance by the recruiter system 8 and prior to transferring the escrow deposit and/or control of the escrow deposit to the escrow system 2.

It is understood that the escrow agreement MSG 3 may stipulate the existence one or more conditions of payment of each escrow deposit portion payment, and may include a stipulation or stipulations (a.) of the continued employment of an individual; (b.) that an individual starts employment with a designated employer and does separate from that employment; and/or (c.) that a tenure of employment with a designated employer is maintained; and/or (d.) that an individual is not currently laid off from work by the employer on leave or on a sabbatical from work with a designated employer.

It is understood that the information content of the escrow agreement MSG 3 may alternately or additionally specify that the condition of employment required for escrow deposit portion payment to be that a candidate referred by the recruiter to the employer (a.) is currently receiving compensation from the employer; (b.) is currently or regularly performing work or providing services to the employer; (c.) is identified by the employer as an employee to government agencies; (d.) is acting or performing in accordance with instructions issued by the employer; and/or (e.) is held to be an employee or contractor of the employer under law applicable in the jurisdiction and law of a work site of the employer or of the candidate.

It is understood that the escrow agreement may stipulate any or all of these four conditions of employment as requirements for continues distribution of escrow deposit portion payments from the escrow deposit to a second party, e.g., a recruiter who referred the employed individual to the designated employer. It is further understood that the escrow agreement may stipulate that when the individual takes leave or goes on sabbatical with the concurrence of the employer that the escrow deposit portion payments may be halted until the individual returns to work with the employer and that upon the return to work of the individual with the designated employer that the escrow deposit portion payments may be resumed by the escrow agent.

The escrow system 2 determines in step 4.08 whether all necessary conditions have been met to authorize and escrow deposit portion payment in step 4.08, and if all conditions are met, determines in step 4.10 whether the immediate payment is a last payment under the terms of the escrow agreement. The escrow agreement may stipulate one or more conditions of payment of on escrow deposit portion payment may include (a.) the continued employment of an individual; (b.) that an individual starts employment with a designated employer and does separate from that employment; and/or (c.) that a tenure of employment with a designated employer is maintained; and/or (d.) that an individual does not take leave or a sabbatical from work with a designated employer. It is understood that the escrow agreement may stipulate any or all of these four conditions of employment as requirements for continues distribution of escrow deposit portion payments from the escrow deposit to a second party, e.g., a recruiter who referred the employed individual to the designated employer. It is further understood that the escrow agreement may stipulate that when the individual takes leave or goes on sabbatical with the concurrence of the employer that the escrow deposit portion payments may be halted until the individual returns to work with the employer and that upon the return to work of the individual with the designated employer that the escrow deposit portion payments may be resumed by the escrow agent.

When the escrow system 2 determines in step 4.10 that the authorized and pending escrow deposit portion payment is not a last payment, the escrow system 2 calculates the value of the immediate payment in accordance with the escrow agreement and issues the escrow deposit portion payment in step 4.12 by electronic transfer or hard copy printed financial instrument. It is understood that there may be more than one beneficiary of one, more, or each escrow deposit portion payment, and that payments to one or more beneficiaries may be executed by electronic funds messaging or by hard copy printed financial instrument.

The escrow system 2 proceeds from step 4.12 to an additional execution of step 4.08.

The escrow system 2 determines in step 4.14 whether one or more escrow agreement termination conditions have been met and if such termination condition or conditions have been met, pays out all remaining funds of the escrow in step 4.16 in accordance with the controlling escrow agreement. The escrow system 2 proceeds from step 4.16 to step 4.18 and to perform additional computational processing.

The escrow system 2 determines in step 4.20 whether one or more pause conditions of the agreement have been met, whereby escrow payment conditions are to be halted until released. The escrow system 2 determines in step 4.22 whether one or more release conditions of the agreement have been met, whereby escrow payment conditions are to be resumed.

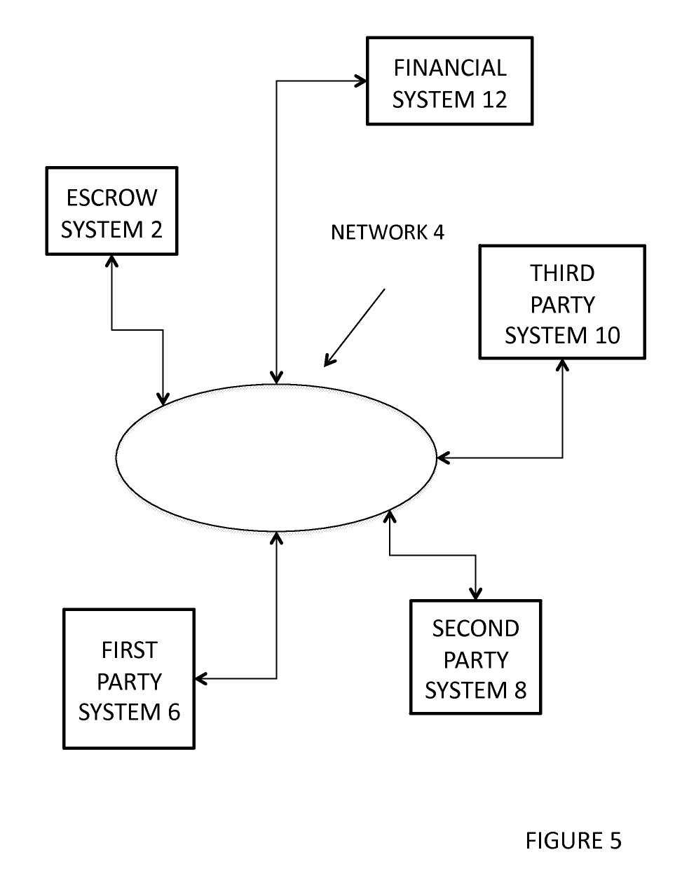

Referring now to FIG. 5, FIG. 5 is a schematic of an electronics communications network 4, e.g., the Internet optionally in combination with a telephony system and/or a wireless electronic communications network, that bi-directionally communicatively couples the escrow system 2 with a first party computer 6 (hereinafter, “the first party system”), a second party computer 8 (hereinafter, “the second party system”), a financial agent computer 10 (hereinafter, “the financial system” 10), and an optional third party computer 12 (hereinafter, “the third system”). The electronics communications network (hereinafter, “the network” 4) enables the first party and the second party to perform the functions of the processes of FIGS. 1 through 4 and 7 and other aspects of the invented method in whole or in part as disclosed herein by electronic communications. The first party system 6, the second party system 8 and/or third party system 12 may be used to provide attestations or alerts to the escrow system 2 to that affect the management of the escrow agreement by the escrow system 2. The financial system 12 is adapted to hold and transfer escrow deposits and escrow payments as directed by the escrow system 2 and optionally other parties or systems.

It is understood that the escrow system 2, or other systems 6, 8, 10 & 12, may be or comprise (a.) a portable communications device; (b.) a THINKSTATION WORKSTATION™ notebook computer marketed by Lenovo, Inc. of Morrisville, N.C., (c.) a NIVEUS 5200 computer workstation marketed by Penguin Computing of Fremont, Calif. and running a LINUX™ operating system or a UNIX™ operating system; (d.) a personal computer or workstation configured for running WINDOWS XP™ operating system marketed by Microsoft Corporation of Redmond, Wash.; (e.) a POWERBOOK G4™ personal computer as marketed by Apple Computer of Cupertino, Calif.; (f.) a MACBOOK PRO™ personal computer as marketed by Apple Computer of Cupertino, Calif.; or (g.) an internet enabled desktop computer; (h.) an IPAD™ touch screen tablet personal computer as marketed by Apple Computer of Cupertino, Calif.; (i) an IPHONE cellular telephone as marketed by Apple Computer of Cupertino, Calif.; or (j) other suitable computational device adapted to receive and render digitized video data known in the art.

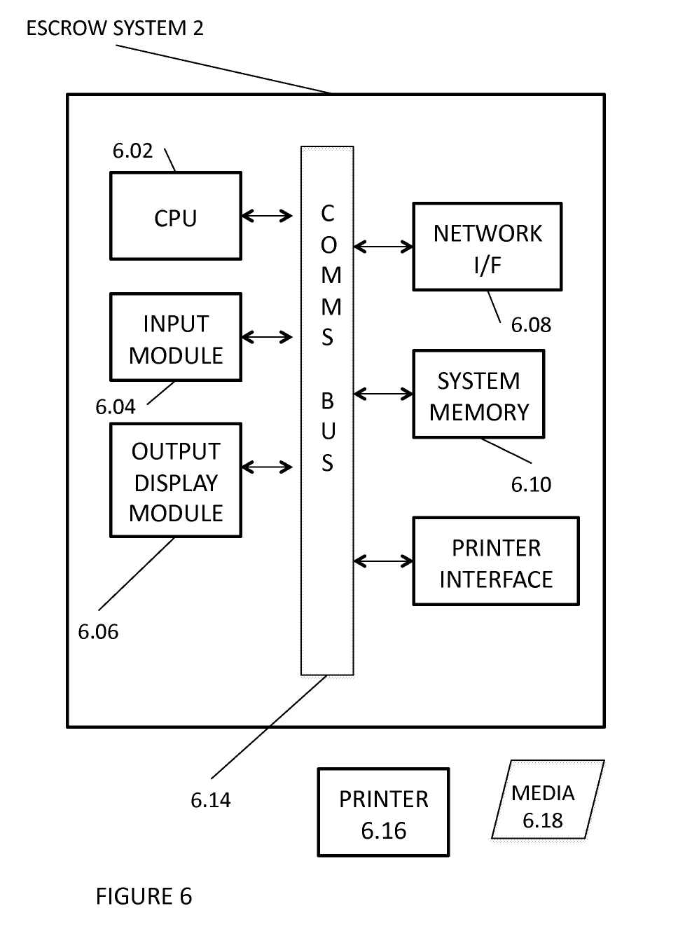

Referring now to FIG. 6, FIG. 6 is a schematic diagram of the elements of the escrow system 2. The escrow system 2 includes a central processing unit 6.02, an input module 6.04, an output display module 6.06, a network interface 6.08, a system memory 6.10, a printer interface 6.12 and an internal communications bus 6.14. The internal communications bus 6.14 bi-directionally communicatively couples the central processing unit 6.02, the input module 6.04, the output display module 6.06, the network interface 6.08, the system memory 6.10 and the printer interface 6.12. The network interface 6.08 bi-directionally communicatively couples the internal communications bus 6.14 and the central processing unit 6.02 with the electronic communications network of FIG. 5. The printer interface 6.12 communicatively couples the central processing unit 6.02 with an external printer 6.16 and enables the escrow system 2 to print hard copies of financial instruments on printed media 6.18.

It is understood that the first party system 6, the second party system 8, the financial system 10 and/or the third party system 12 may comprise any or all of the elements 6.02-6.14, capabilities and aspects of the escrow system 2.

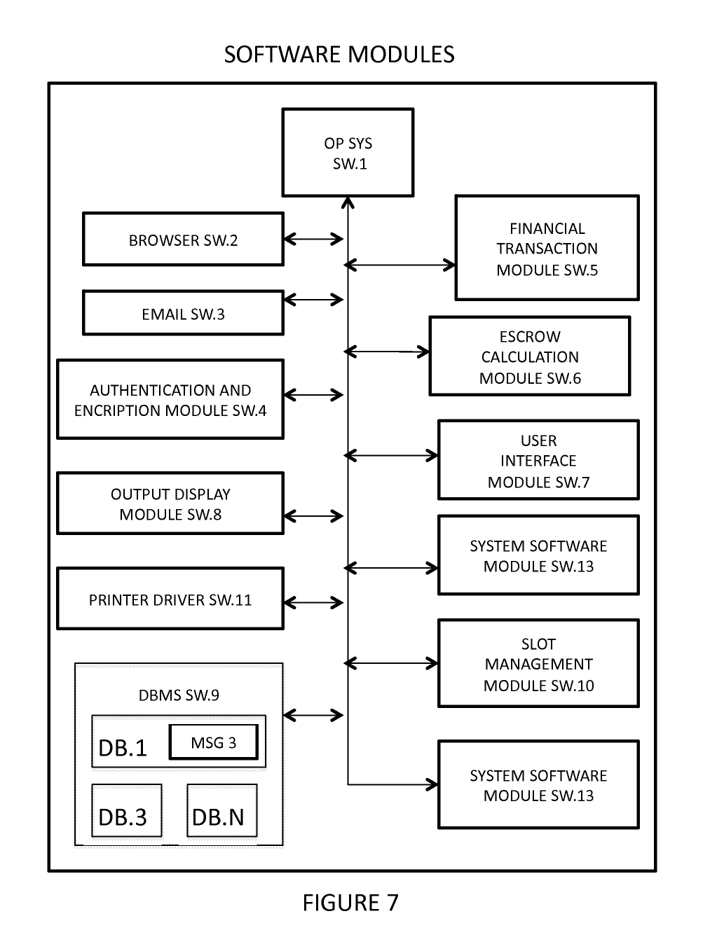

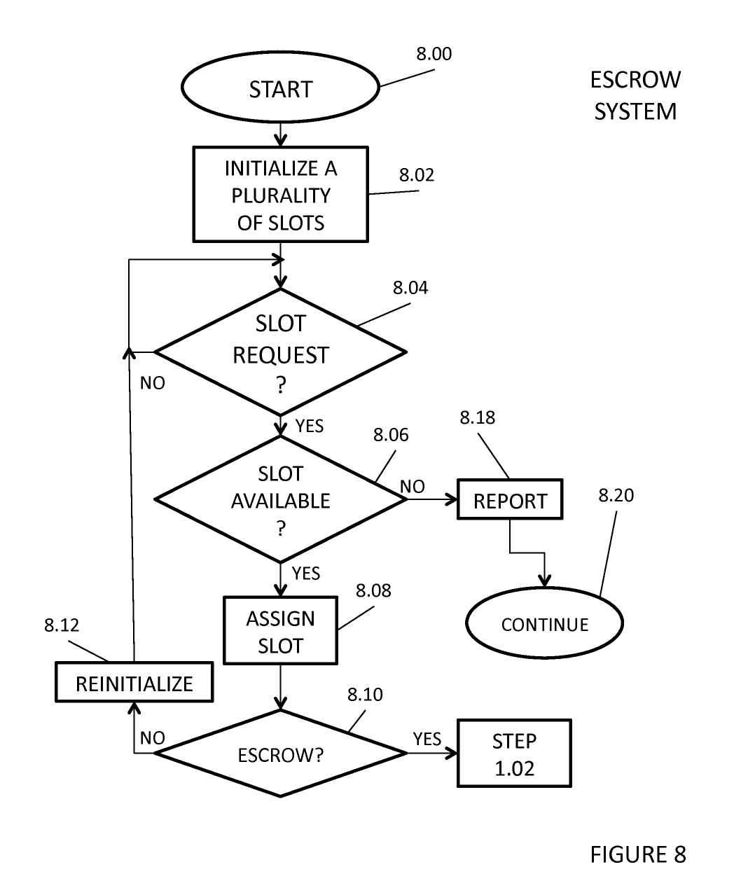

FIG. 7 is a schematic diagram of optional software module set SW.1-SW.14 of the escrow system 2 and optionally of one or more alternate systems 6, 8, 10 & 12. The software module set includes a software operating system SW.1, a web browser SW.2, an email client SW.3, a communications authentication and encryption module SW.4, a financial transaction module SW.5, an escrow calculation payment module SW.6, a user interface module SW.7, an output display module SW.8, a database management system SW.9 comprising one or more databases DB.1-DB.N, a slot management module SW.10, a printer driver SW.11, an escrow negotiation and agreement generation software module SW.12 (hereinafter, “escrow interface software” SW.12), and a system software module SW.13. The escrow payment calculation module SW.6 enables the escrow system 2 to calculate escrow payments as derived at least in part from the escrow agreement MSG 3 of FIG. 7. The slot management module SW.10 enables the escrow system 2 to perform the steps of the method of FIG. 8. The printer driver SW.11 enables the host system 2, 6, 8, 10 & 12 to operate the printer 6.16 to print hard copy financial instruments on the hard copy print media 6.18.

The escrow interface software SW.12 enables the escrow system 2 and other systems 6, 8, 10 & 12 hosting the escrow interface software SW.12 to enable the electronically mediated negotiation, modification and generation of a governing escrow agreement and the ESCROW AGREEMENT MSG 3 as disclosed within the present disclosure.

The system software module SW.13 enables the escrow system 2 and other systems 6, 8, 10 & 12 hosting the escrow interface software SW.12 and the system software module SW.13 to perform one, more, or all of the aspects of the method of the present invention as disclosed in the present disclosure.

It is understood that the first party system 6, the second party system 8, the financial system 10 and/or the third party system 12 may comprise any or all of the software modules SW.1-SW.14, software enabled capabilities and aspects of the escrow system 2.

FIG. 8 is a flowchart of an escrow slot management process as performed by the escrow computer 2. In step 8.02 the escrow system 2 initiates a plurality of escrow records E.REC.1-E.REC.N that are reserved as slots S.1-S.N or within slots S.1-S.N to be assigned to separate and individual escrow agreements. In step 8.04 a request to assign a reserved escrow record to an identified escrow agreement is received by the escrow system. The escrow system determines in step 8.06 if a reserved escrow record E.REC.1-E.REC.N is available for a new assignment to an escrow agreement. When the escrow system determines in step 8.06 that a reserved escrow record E.REC.1-E.REC.N is available for a new assignment to an escrow agreement, a reserved escrow record E.REC.1-E.REC.N is selected and assigned in step 8.08.

It is understood that the disclosure herein of an exemplary first escrow record E.REC.1 describes aspects and features that may be applied to other escrow records E.REC.2-E.REC.N.

The escrow system 2 determines in step 8.10 whether an escrow agreement has been assigned to the reserved escrow record E.REC.1-E.REC.N selected and assigned in step 8.08. When the escrow system 2 determines in step 8.10 whether an escrow agreement has been assigned to the first escrow record E.REC.1 the escrow system proceeds on to execute step 1.02 of FIG. 4.

When the escrow system 2 determines in step 8.10 that an escrow agreement has been not assigned to the reserved escrow record, the escrow system 2 proceeds on to step 8.12 and to reinitialize the first escrow record E.REC.1 to make the first escrow record E.REC.1 available for reassignment to another escrow agreement. The escrow system 2 proceeds from step 8.12 to step 8.04.

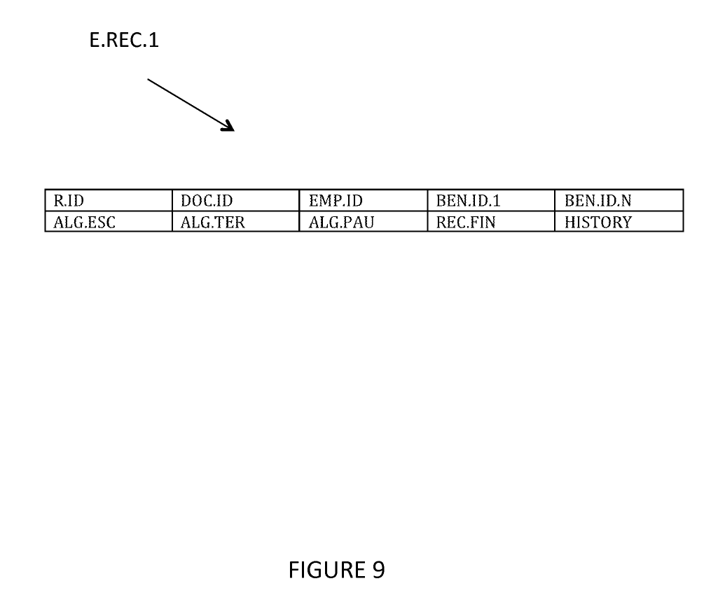

FIG. 9 is a representation of the exemplary escrow agreement record E.REC.1 that enables the escrow system 2 of FIGS. 4 through 7 to manage and execute an escrow agreement of FIGS. 1 through 3. The exemplary escrow record 2 is populated with information and optionally instructions that enable or support an execution of an escrow agreement in whole or in part by the escrow system 2. The first escrow record E.REC.1, and additional escrow records E.REC.2-E.REC.2 may be stored in one or more databases of the DBMS SW.9. It is understood that some or all of the information and/or instructions stored in the first escrow record E.REC.1 may be stored in duplication in one or more of the systems 2, 6, 8, 10 & 12 of FIG. 5.

A record identifier R.ID uniquely identifies the exemplary first escrow record E.REC.1 to the escrow system 2. An escrow document identifier DOC.ID uniquely identifies to the escrow system 2 a selected escrow agreement that is assigned to the exemplary first escrow record E.REC.1. An employer identifier EMP.ID uniquely identifies the employer signatory to the escrow system 2 and may include a network address of the employer signatory. One or more beneficiary identifiers BEN.ID.1-BEN.ID.N each uniquely identifies an individual beneficiary of the governing escrow agreement to the escrow system 2. Each beneficiary identifier BEN.ID.1-BEN.ID.N may include a network address of a beneficiary identified in by the comprising beneficiary identifier BEN.ID.1-BEN.ID.N. The beneficiary identifier BEN.ID.1-BEN.ID.N may also contain addressee information for electronic transmission of escrow portion payments and/or delivery of hard copy financial instruments 6.18 for transmission of escrow portion payments.

An escrow algorithm ALG.ESC contains an algorithm and/or instructions that direct the escrow system 2 to determine to which parties, at what addresses at what times, and in what amounts each of one or more escrow portion payments are to be issued. A termination algorithm ALG.TER contains an algorithm and/or instructions that direct the escrow system to determine when to terminate an escrow agreement and further how and to whom to deliver remaining funds of the escrow deposit. A pausing algorithm ALG.PAU contain an algorithm and/or instructions that direct the escrow system to determine when and if to pause issuing escrow portion payments. The pausing algorithm may further comprise an algorithm and/or instructions that direct the escrow system 2 to determine when and if to resume issuing escrow portion payments after a pause in issuing escrow portion payments. A financial record data field FIN.REC includes information related to and enabling transferring funds to and from an escrow account formed by the escrow agreement associated by the escrow document identifier DOC.ID. An optional history data field HISTORY includes one or more notations relating to the escrow deposit, the employer, one or more escrow portion payment beneficiaries, one or more issued escrow portion payments, and/or interactions of the escrow system 2 related to the exemplary escrow record.

In an illustrative example, imagine that an escrow deposit equals US$36,020.00 and the escrow algorithm ALG.ESC is programmed to provide 36 substantially equal months payments. The escrow ALG.ESC may thus direct the escrow system 2 to transfer US$1,000.00 in 35 monthly payments to the recruiter system 2 dependent on the conditions of the escrow employment agreement offer as offered by the employer and accepted by the recruiter. A final payment of US$1,020.00 would then be transferred after the 36th month of consecutive employment performance by the individual referred to in the electronic escrow agreement MSG 3. Alternately or additionally, the escrow agreement MSG 3 might direct the escrow system to transfer or pay out to the recruiter and/or the recruiter system each monthly paymentby electronic messaging or delivery of hard copy financial instruments.

Alternately, the escrow algorithm ALG.ESC might comprise a listing of timed payments of pre-specified amounts to be transferred or paid out to the recruiter and/or the recruiter system by electronic messaging or delivery of hard copy financial instruments. Still alternately or additionally, the escrow agreement MSG 3 might direct the escrow system to transfer or pay out to another party or other system 10 & 12 a fraction or part of one or more escrow deposit payments by electronic messaging or delivery of hard copy financial instruments.

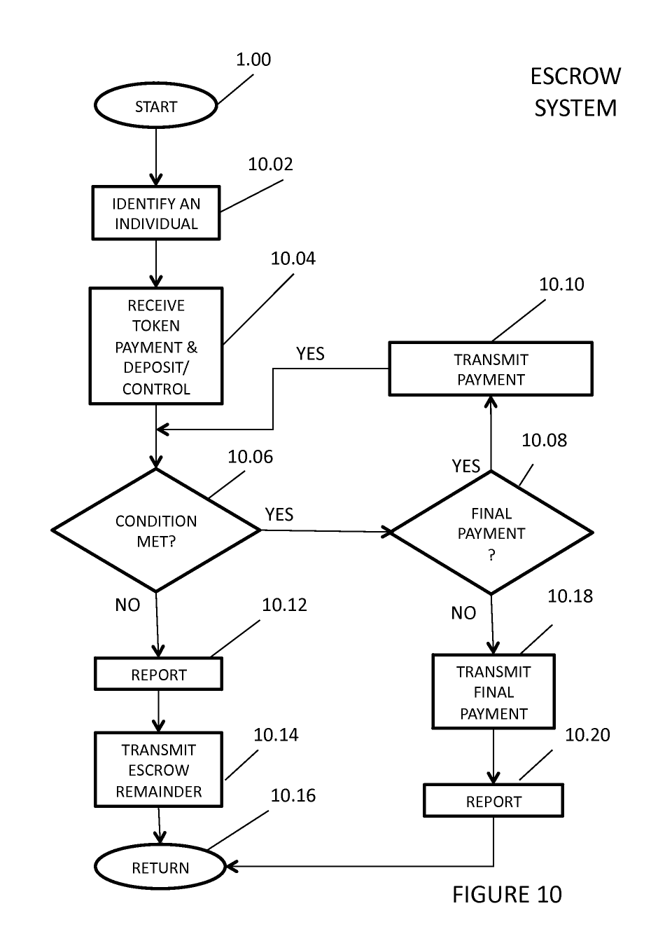

Referring now to FIG. 10, additional optional aspects of the method of the present invention are provided within a payment process wherein an individual is identified in step 10.02 and an escrow agent or the escrow system 2 receives control of an escrow deposit in step 10.04. It is understood that the escrow may be maintained by the financial system 12 while information provided to the escrow system 2 enables the escrow agent to control the disposition, transfer, disbursement and/or funds withdrawal of the escrow deposit. An employer of the individual identified in step 10.04 may be the party providing the escrow deposit or control of the escrow deposit, of step 10.04 to the escrow agent or escrow system 2.

Alternatively or additionally, the escrow deposit and/or control of the escrow system 2 may be delivered in step 10.04 to the escrow agent or escrow system 2 by means that provide a financial instrument comprising an automated clearing house transfer, a wire transfer, an electronic funds transfer, a bank check, a personal check, a cashiers check, a postal money order and/or a money order. Optionally, alternatively or additionally, the monetary value of the escrow deposit of step 10.04 (hereinafter, “the escrow deposit”) may be calculated at least partially on the basis of an element of a compensation amount offered by an employer to the individual identified in step 10.02. For example, the escrow deposit may be calculated as a fraction or a percentage of a salary offered to the individual identified in step 10.02 (hereinafter, “the individual”), such as one fourth of an annual salary offered by an employer to the individual or 30% of an annual salary offered by an employer to the individual.

In step 10.06 an escrow agent or an escrow system 2 determines whether an employment condition of the individual as specified by the governing employment agreement described in the escrow agreement MSG 3 has been met. The determination of the continued existence of the employment condition of step 10.06 may be supported by a timely acknowledgment, admission, or attestation provided by an employer of the individual identified on step 10.02 (herein after, “the employer”), and/or be a government agency or third party, wherein the acknowledgment, admission, or attestation may be provided to the escrow agent or escrow system 2 by electronic messaging via the network 4, by voice conversation over a telephony network, or by written notification. Alternately or additionally, the condition of employment may be presumed to exist by the escrow agent or escrow system 4, when stipulated by the governing escrow agreement, when the employer fails to alert the escrow agent or escrow system 2 that the condition of employment has lapsed.

When the escrow agent or escrow system 2 determines in step 10.06 that the applicable employment condition of the individual has been met, the escrow agent or escrow system 2 proceeds from step 10.06 to step 10.08 and to determine whether the immediate payment is a final payment in accordance with the governing escrow agreement. When the escrow agent or escrow system 2 determines in step 10.08 that the immediate payment is not a final payment, the escrow agent or escrow system 2 proceeds onto step 10.08 and transmits an escrow deposit accordance payment in accordance with the governing escrow agreement as described in the escrow agreement MSG 3. Alternatively or additionally, the escrow deposit portion payment may be delivered in step 10.10 to a beneficiary as designated by the governing escrow agreement by means that provide a financial instrument comprising an automated clearing house transfer, a wire transfer, an electronic funds transfer, a bank check, a personal check, a cashiers check, a postal money order and/or a money order. The escrow agent or escrow system 2 proceeds from step 10.10 to an additional execution of step 10.06. It is understood that a time delay may be imposed between successive performances of step 10.10 on accordance with the governing escrow agreement, e.g., successive escrow deposit portion payments may be made by individual executions of step 10.10 periodically, such as on a monthly or a quarterly payment basis or schedule.

It is further understood that one or more of the escrow deposit portion payments deducted from or paid from the same escrow deposit of step 10.04 may be (a.) substantively equivalent in denomination; (b.) sized in a graduated decline and decrease from an earlier escrow deposit portion payment of a series of escrow portion payments; (c.) sized in a graduated rise and increase from an earlier escrow deposit portion payment of a series of escrow deposit portion payments; (d.) may be a balloon payment being larger in monetary value than other escrow deposit portion payments. It is further understood that a first escrow deposit portion payment paid from the escrow deposit of step 10.04 and/or a escrow deposit portion payment paid from the escrow deposit of step 10.04 may be a balloon payment, i.e., larger in monetary value than other escrow deposit portion payments paid out from the escrow deposit of step 10.04.

When the escrow agent or escrow system 2 determines in step 10.06 that the applicable employment condition of the individual ceased, the escrow agent or escrow system 2 proceeds from step 10.06 to step 10.12 and to report the determination of step 10.06 and to halt payments. A cessation of the employment condition of step 10.06 may be determined by (a.) a separation from an employment position by the individual identified in step 10.02; and/or (b.) a cessation of employment in an employment position by the individual identified in step 10.02.

Funds of the escrow deposit remaining under the control of the escrow agent or escrow system 2 are then transmitted to an employer of the individual, and/or other as stipulated in the governing escrow agreement or by operation of law by the escrow agent or escrow system 2 in step 10.14. The escrow agent and/or escrow system 2 proceeds from step 10.14 to perform other or additional process steps in step 10.16. When the escrow agent 2 or escrow system determines in step 10.08 that the immediate payment is a final payment, the escrow agent or escrow system 2 proceeds on to step 10.18 and to execute a final escrow deposit portion payment. The final escrow deposit portion payment may be delivered in step 10.18 to a beneficiary as designated by the governing escrow agreement by means that provide a financial instrument comprising an automated clearing house transfer, a wire transfer, an electronic funds transfer, a bank check, a personal check, a cashiers check, a postal money order and/or a money order. The escrow agent or escrow system 2 may then report the transfer of the final escrow deposit portion payment of step 10.20, and proceeds form step 10.20 to step 10.16 and to perform additional or alternative process steps.

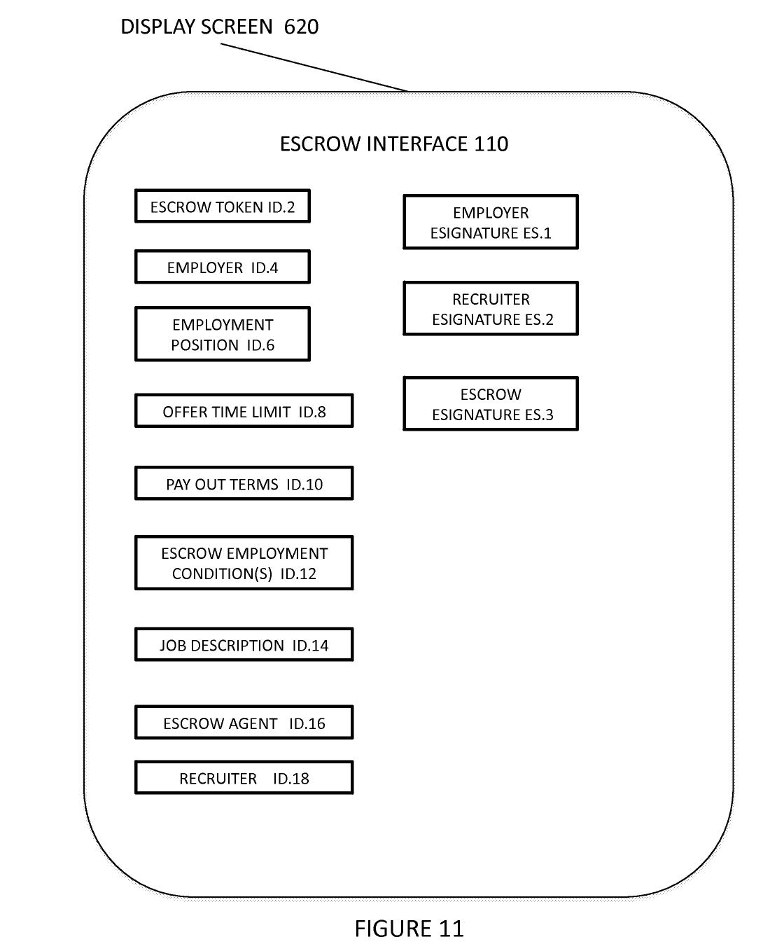

Referring now to FIG. 11, FIG. 11 is a representation of an escrow interface input screen 110 that is generated on the display screen 620 of the output display module 6.06 of the escrow system 2, or other system 6, 8, 10, & 12 accessible to an employer, a recruiter, an escrow agent, or other third party. The escrow interface input screen 110 may be a webpage generated by the webserver SW.14 of system 2, 6, 8, 10, 12 and rendered by the instant system 2, 6, 8, 10 & 12 presenting the escrow interface input screen 110.

A user of the an escrow interface 110 may employ the user interface input screen 110 to, as enabled by the escrow interface software SW.12 and the system software SW.13, to negotiate, modify, co-author, generate, reject and/or accept escrow agreement offers and the escrow agreement MSG 3. The user may identify an escrow token T.1-T.N issued by the escrow system 2 and associate the identified escrow token T.1-T.N with the exemplary first escrow record E.REC.1 by input of an escrow token identifier into a token input dialogue box ID.2. The user may additionally employ the escrow interface input screen 110 to (a.) identify an employer (hereinafter, “the employer”) issuing an escrow agreement offer in an employer dialogue input box ID.4; (b.) input an identification of a position of employment offered by the identified by the employer in an employment position dialogue input box ID.6; (c.) input into a time limit input dialogue input box ID.8 an indication of a time limit during which the employer will permit an escrow offer to be negotiated and made available to a recruiter (hereinafter, “the recruiter”) to perform under the terms of an escrow agreement by referring a candidate who accepts employment with the employer; (d.) input the terms in a pay out terms into input box ID.10 of terms and scheduling stipulations under which an earned escrow deposited will be paid out to the recruiter should the recruiter meet the terms and conditions of the escrow agreement; (e.) input an employment condition or conditions in an escrow employment condition(s) dialogue input box ID.12; (f.)) input a job description into a job description dialogue input box ID.14; (g.) input an escrow agent identifier associated with an escrow agent (hereinafter, “the escrow agent”) and/or the escrow system 2 into an escrow agent dialogue input box ID.16; (h.)) input a recruiter identifier associated with the recruiter and/or a second party system 6 into a recruiter identifier dialogue input box ID.18; (i.) input an employer electronic signature input dialogue box ES.1 wherein the employer or an agent of the employer may enter a legally binding electronic signature on behalf of the employer; (j.) input a recruiter electronic signature input dialogue box ES.2 wherein the recruiter or an agent of the recruiter may enter a legally binding electronic signature on behalf of the recruiter; and (j.) input an escrow electronic signature input dialogue box ES.3 wherein the escrow agent or an agent of the escrow agent may enter a legally binding electronic signature on behalf of the escrow agent.

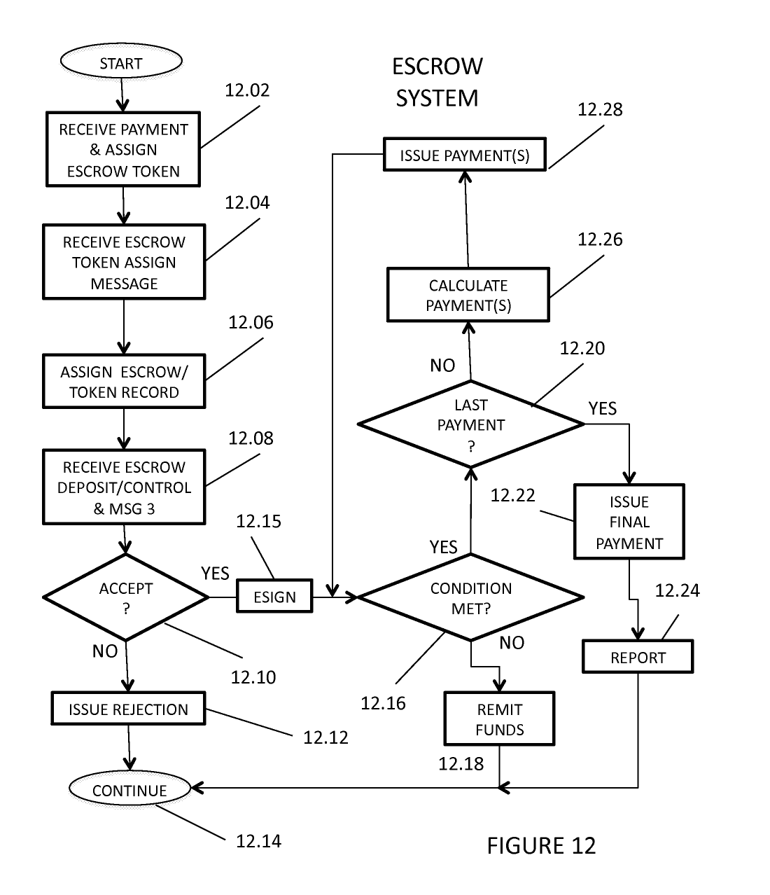

Referring now to FIG. 12, FIG. 12 is a flow chart of certain optional aspects of the method of the present invention as performed by an escrow agent in concert with the escrow system 2. In step 12.02 the escrow system receives payment for an escrow token record T.1-T.N and creates a token record. The token record payment may be received from the recruiter, the employer, or other party. In step 12.04 the escrow system receives a request from the purchaser of the token record of step 12.02 to assign an escrow record E.REC.1-E.REC.N or a token record T.1-T.N to a particular employment escrow process. An exemplary first token record T.1 will be discussed regarding FIG. 12, and it is understood that the process of FIG. 12 may be applied with, by and to alternate token records T.2-T.N.

In step 12.08 the escrow system 2 receives the escrow agreement MSG 3 and either (a.) an escrow deposit; or (b.) control over an escrow deposit maintained by the financial system 12. The escrow deposit or control may be delivered or transferred to the escrow system by electronic messaging or by hard copy printed financial instrument. It is understood that step 12.08 may alternately be performed after step 12.15 and before step 12.16 as disclosed herein.

The escrow agent determines in step 12.10 whether to accept the terms of the escrow agreement MSG 3. When the escrow agent determines in step 12.10 to reject the terms of the escrow agreement MSG 3, the escrow deposit of step 12.08 is returned or inhibited for acceptance by the escrow system 2, and a notice of rejection is communicated by the escrow agent or the escrow system in step 12.12. The escrow system 2 proceeds from step 12.12 to step 12.14 and to perform alternate computational operations.

When the escrow agent determines in step 12.10 to accept the terms of the escrow agreement MSG 3, the escrow agent directs the escrow system to issue an electronic signature and the escrow system 2 and the escrow agent proceeds on in steps 12.16 through 12.28 to perform the escrow agreement MSG 3. In step 12.16 the escrow system 2 and/or the escrow agent determine whether each necessary condition of employment as stipulated in the escrow agreement MSG 3 as prerequisites for an issuance of an escrow deposit payment have been satisfied or are in existence. It is understood that the escrow agreement may stipulate that a failure of the escrow agent or escrow system 2 to receive an alert of the failure of a condition or non-existence of a condition is required for the escrow agent or the escrow system 2 to determine that a escrow deposit portion payment shall not be issued.

When the escrow agent or escrow system 2 determines in step 12.6 that all necessary conditions for issuance of an escrow deposit portion payment under the escrow agreement MSG 3 have not been met or are not in existence, the escrow system 2 proceeds on either automatically or under direction of the escrow agent to step 12.18 and to remit all remaining funds of the escrow deposit that are either in possession of or under control of the escrow system 2 or the escrow agent to the employer or to another party as stipulated by the escrow agreement MSG 3. The remission of funds of step 12.18 may be accomplished by delivery or transfer to the escrow system by electronic messaging or by hard copy printed financial instrument. The escrow system 2 proceeds from step 12.18 to step 12.14 and to perform alternate computational operations.

When the escrow agent or escrow system 2 determines in step 12.6 that all necessary conditions for issuance of an escrow deposit portion payment under the escrow agreement MSG 3 have been met or are in existence, the escrow system 12.02 proceeds on to step 12.20 and to determine whether the immediate escrow deposit portion payment is a final payment. It is understood that the escrow agreement 3 may stipulate that the entire escrow deposit is to be transferred in a single payment, wherein a first escrow deposit payment is also a final and last escrow deposit payment. When the escrow system 2 or the escrow agent determines in step 12.20 that the immediate escrow deposit payment is a final payment from the escrow deposit of step 12.08, the escrow system 2 proceeds issue the final escrow deposit portion payment in step 12.22 by electronic messaging or hard copy printed financial instrument and thereform to step 12.24 to report to the first party system 6 and/or the second party system 8 that the entire escrow deposit has been paid out. When the escrow system 2 or the escrow agent determines in step 12.20 that the immediate escrow deposit payment is not a final payment from the escrow deposit of step 12.08, the escrow system calculates the monetary value of the immediate escrow deposit portion payment in step 12.26, optionally on the basis of the algorithm of the first escrow record E.REC.1 or other algorithm or instruction of the escrow agreement MSG 3 or other escrow record E.REC.2-E.REC.N as stipulated by the escrow agreement 3. The escrow system 2 proceeds on from step 12.26 to step 12.28 to issue the immediate escrow deposit portion payment by either electronic messaging or issuance of a hard copy printed financial instrument in step 12.28. The escrow agreement proceeds form step 12.28 to another execution of step 12.16.

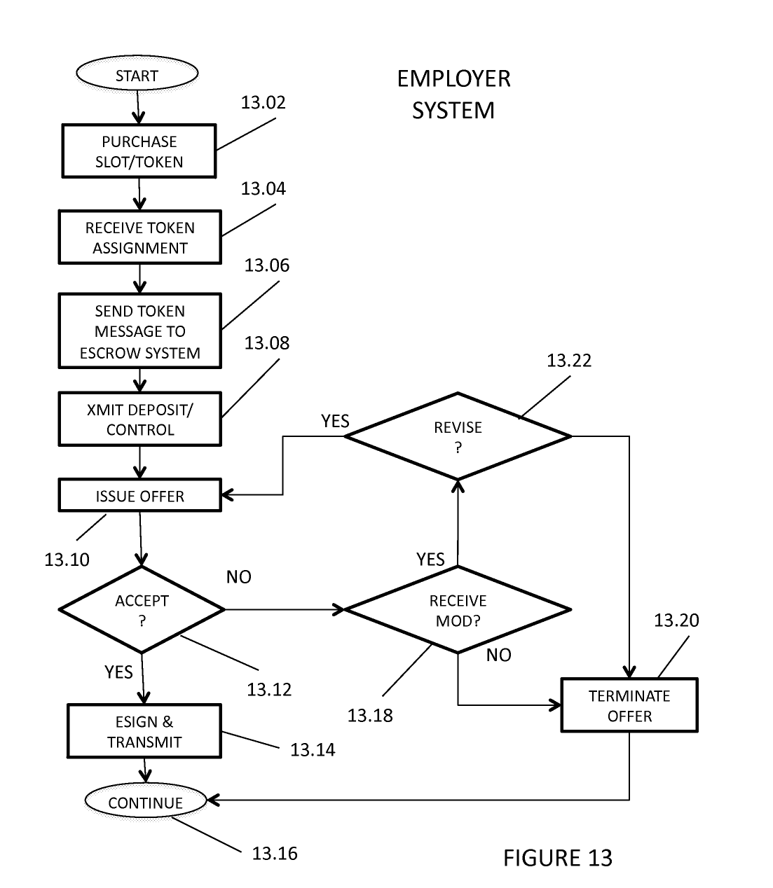

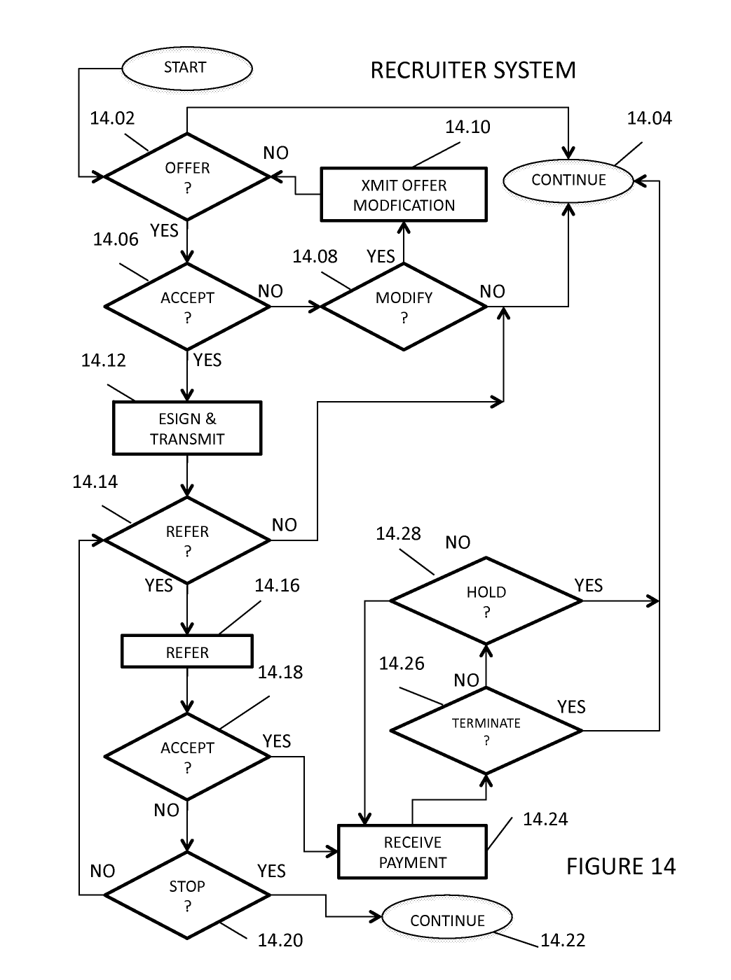

Referring now to FIG. 13, FIG. 13 is a flow chart of certain other additional aspects of the invented method that may be performed by the first party system 6, or employer system 6, in concert with the employer or an agent of the employer. In step 13.02 the employer system 6 purchases access to one or more token records T.1-T.N or a series of slots form the escrow system 2. In step 13.04 the employer system 6 receives a reference to the exemplary token record T.1 as maintained by the escrow system 4. In step 13.06 the employer system 6 assigns the exemplary first token T.1 to an identified job opening, i.e., a particular employment position with the employer. In step 13.10 the employer system 2 electronically issues an offer to the second party system 8, or recruiter system 8, via the network 2 by means of populated the exemplary token record T.1 and/or the exemplary first escrow record E.REC.1 via the escrow interface 110 as generated by the escrow interface module SW.7 and/or the system software SW.13. It is understood that the employer system 6 may cancel or nullify the escrow payment offer prior to acceptance by a recruiter system 8 and prior to transferring either the escrow deposit, or control of the escrow deposit, to the escrow system 2.

The employer system 6 determines in step 13.12 whether an acceptance of the offer of step 13.10 has been received from the recruiter system 8 via the network 2. When the employer system 6 or the employer determines in step 13.12 that an acceptance of the offer of step 13.10 has been received from the recruiter system 8 via the network 2, the employer system 2 issues an electronic signature within the escrow agreement MSG 3 and transmits electronic copies of the escrow agreement MSG 3 to the escrow system 2 and optionally to the recruiter system 8 and/or the financial system 12 in step 13.14. The employer system 6 proceeds on from step 13.14 to step 13.16 and to perform additional computational processes in step 13.16.

When the employer system 6 or the employer determines in step 13.12 that an acceptance of the offer of step 13.10 has not been received from the recruiter system 8 via the network 2, the employer system 2, the employer system 6 proceeds on to step 13.18 and to determine whether a request to modify the terms of the escrow agreement MSG 3 has been received. If the employer system 6 determines that a request to modify the terms of the escrow agreement MSG 3 has not been received in step 13.18, the employer system 6 proceeds on to step 13.20 and to terminate the escrow agreement offer. The employer system 6 proceeds on from step 13.20 to step 13.16 and to perform additional computational processes in step 13.16.

If the employer system 6 determines that a request to modify the terms of the escrow agreement MSG 3 has been received in step 13.18, the employer system 6 and/or the employer proceeds on to step 13.22 and to determine whether to incorporate the requested modification within, or otherwise revise, the terms and conditions of the escrow agreement MSG 3. When the employer determines to revise the offer of the escrow agreement MSG 3, the employer and/or the employer system 6 revises the escrow agreement offer and proceeds from step 13.22 to step 13.10 to modify the escrow agreement MSG 3 and to issue a revised offer in an additional execution of step 13.10. When the employer declines in step 13.22 to revise the offer of the escrow agreement MSG 3, employer system 6 proceeds from step 13.22 to step 13.20 and to terminate the escrow agreement offer of the last execution of step 13.10.

Referring now to FIG. 14, FIG. 14 is a flow chart of yet additional optional aspects of the invented method that may be performed in concert by the recruiter with the recruiter system 8. In step 14.02 the recruiter system determines if an offer of an escrow agreement MSG 3 has been received by electronic messaging via the network 2. When no offer is detected by the recruiter system 8 in step 14.02, the recruiter system proceeds on to step 14.04 to perform alternate computational operations. When a received offer is detected by the recruiter system 8 in step 14.02, the recruiter system proceeds on to step 14.06 to determine if the recruiter accepts the offer. The recruiter may optionally author and direct the recruiter system 8 to form an electronic modification request message in step 14.08 and to transmit the electronic modification request message via the network and possibly addressed to the employer system 6 and/or other system 10 & 12.

When the recruiter elects in step 14.06 to accept the offer of step 14.02, the recruiter directs the recruiter system 8 to provide an electronic signature to the escrow document MSG 3 via the escrow interface 110 as generated by the escrow interface module SW.7 and/or the system software SW.13. The recruiter then proceeds on to step 14.14 and to optionally direct the recruiter system 8 to refer employment candidates by electronic messaging to the employer system 6. When the recruiter system fails to receive a candidate acceptance message from the employer or the employer system 6, or via the network 24, in step 14.20, wherein the candidate acceptance message would indicate that a candidate referred by the recruiter has been accepted employment with the employer, the recruiter determines in step 14.20 whether to refer additional employment candidates by another performance of steps 14.14 through 14.16. The recruiter may elect to cease directing the recruiter system 8 referring additional employment candidates, whereupon the recruiter system 8 proceeds form step 14.20 to step 14.22 and to perform alternate computational operations.

Alternatively, when the recruiter system 8 receives a candidate acceptance message from the employer system 6 or via the network 4 in step 14.18, the recruiter system 8 optionally proceeds on to receive a first escrow deposit portion payment in step 14.24 and optionally additional payments until the escrow deposit portion payments are terminated by the escrow system 2 as per step 14.26 or paused or put on hold by the escrow system 2 as per step 14.28. The recruiter system 8 proceeds from steps 14.26 or 14.28 to step 14.04 and to perform alternate computational actions.

Referring now to FIG. 15, FIG. 15 is a flow chart of even additional optional aspects of the invented method that may be performed in concert by the recruiter with the recruiter system 8. In step 15.02 the recruiter purchases a token T.1-T.N or a plurality of slots S.1-S.N by means of electronic communication via the recruiter system 8 and the escrow system 2. In step 15.04 the recruiter system 8 receives a notice of an assignment of an exemplary first token T.1 to the draft and unsigned escrow agreement MSG 3. In step 14.06 the recruiter system optionally associates the exemplary first escrow record E.REC.1 with the escrow agreement MSG 3 and the first token T.1. In step 15.08 the recruiter completes a draft of the escrow agreement MSG and transmits the draft escrow agreement MSG 3 to the employer system 6. In step 15.10 the recruiter system 8 determines whether an escrow agreement offer had been received via the network 2. When no escrow agreement offer has been detected by the recruiter system 8, the recruiter system 8 proceeds from step 15.10 to step 15.12 and to perform additional computational operations. Alternatively, when the recruiter system 8 receives an escrow agreement offer in step 15.10, the recruiter reviews the received offer in step 15.14 and determines whether to accept the escrow agreement offer. When the recruiter elects in step 15.14 to accept the escrow agreement offer of step 15.10, the recruiter directs the recruiter system 8 on to step 15.16 and provides an electronic signature to the escrow agreement MSG 3 via the escrow interface 110 as generated by the escrow interface module SW.7 and/or the system software SW.13. The recruiter system 8 proceeds from step 15.16 to step 14.14 and to initiate referring candidates for employment.

When the recruiter elects in step 15.14 to not accept the escrow agreement offer of step 15.10, the recruiter may elect in step 15.18 to modify the offer received in step 15.10 and to transmit a modified draft escrow agreement MSG 3 to the employer system 6 in step 15.20. The recruiter system proceeds form step 15.20 to step 15.10.

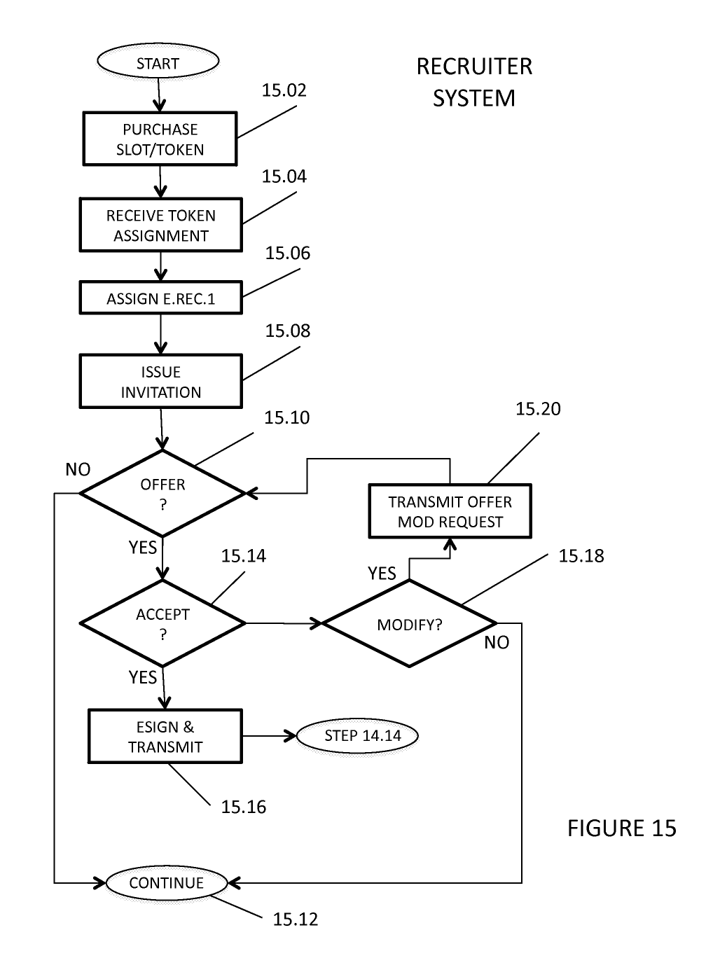

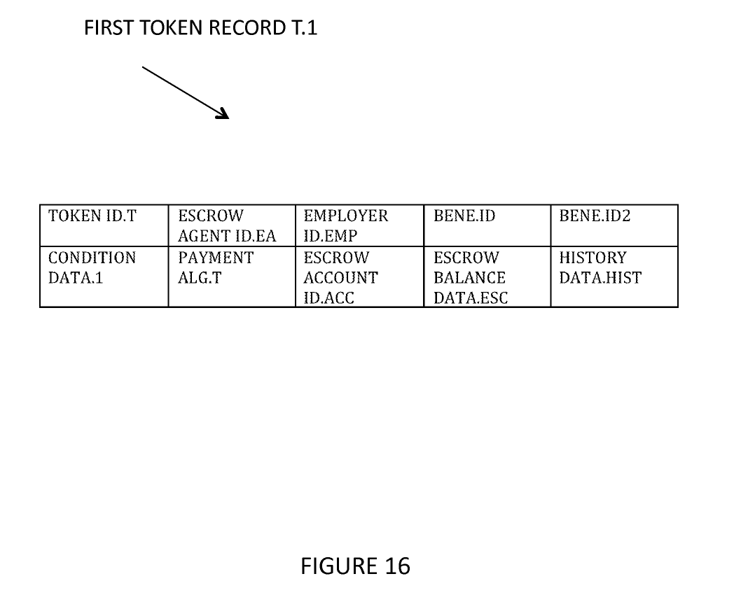

Referring now to FIG. 16, FIG. 16 is a schematic illustration of the exemplary first token T.1. The first token T.1 is an electronic document that may be populated with certain information, to include (a.) a token identifier T.1 that uniquely identifies the first token T.1 to the systems 2, 6, 8, 10 & 12 of FIG. 5; (b.) an escrow identifier ID.EA of an escrow agent who is operating the escrow system 2 and optionally a network address of the escrow system 2; (c.) an employer identifier ID.EMP of the employer and optionally a network address of the employer system 6; (d.) an beneficiary identifier BENE.ID of the recruiter or other intended recipient of fractions or all of one or more escrow deposit portion payment and optionally a network address of the recruiter system 8; (e.) one or more additional beneficiary identifiers BENE.ID2 of other intended recipient of fractions or all of one or more escrow deposit portion payment and optionally a network address of an alternate system 10; (f.) information disclosing an employment condition required for payment of one or more escrow deposit portion payments DATA.1; (h.) an algorithm ALG.T for use by the escrow system 2 in to determining the timing and monetary value of one or more escrow deposit portion payments; an escrow account identifier ID.ACC; (i.) an escrow account monetary balance DATA.ESC; and (j.) a history of messages and transactions related to the first token T.1, the escrow agreement MSG 3, and/or the referenced escrow account identifier ID.ACC, to include a record of the of the monetary value of the initial escrow deposit. It is understood that the first token T.1, the escrow account identifier ID.ACC and the employment condition information DATA.1 are each preferably associated or associable with the escrow document MSG 3.

It is understood that the information content of the employment condition information DATA.1 is preferably comprised within the escrow agreement MSG 3 and may specify that a candidate referred by the recruiter to the employer (a.) is currently receiving compensation from the employer; (b.) is currently or regularly performing work or providing services to the employer; (c.) is identified by the employer as an employee to government agencies; (d.) is acting or performing in accordance with instructions issued by the employer; and/or (e.) is held to be an employee or contractor of the employer under law applicable in the jurisdiction and law of a work site of the employer or of the candidate.

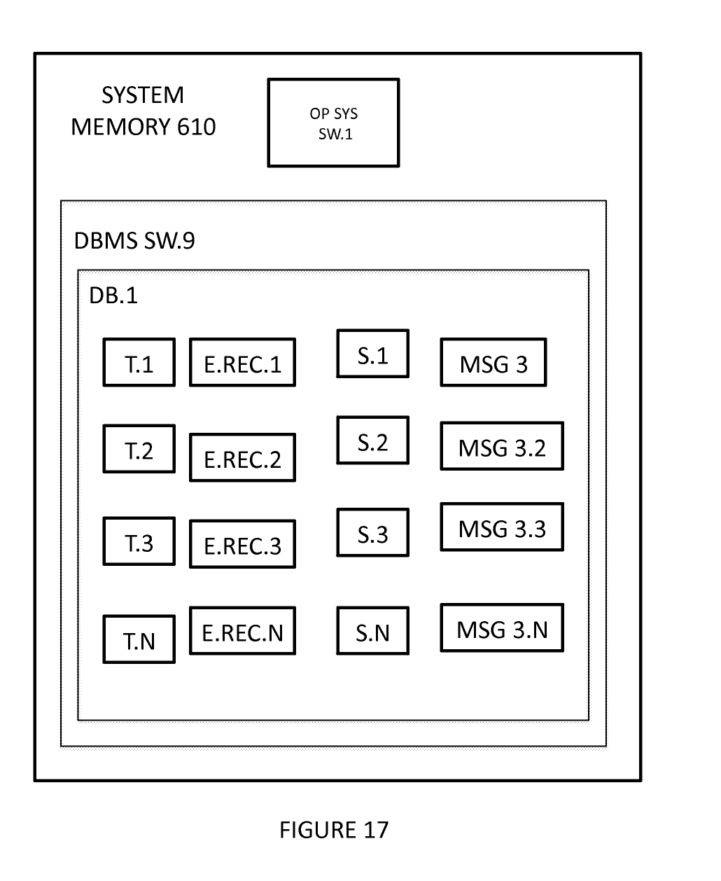

Referring now to FIG. 17, FIG. 17 is a schematic representation of the system memory 610 of escrow system 2 showing the recordation in a first exemplary database DB.1 of tokens T.1-T.N, escrow records E.REC.1-E.REC.N, slots S.1-S.N and a plurality of escrow documents MSG 3-MSG 3.N. It is understood that additional systems 6, 8, 10 & 12 include separate and dedicated system memories 610 that include data bases DB.1-DB.N may also store originals or duplicative copies of tokens T.1-T.N, escrow records E.REC.1-E.REC.N, slots S.1-S.N and a plurality of escrow documents MSG 3-MSG 3.N.

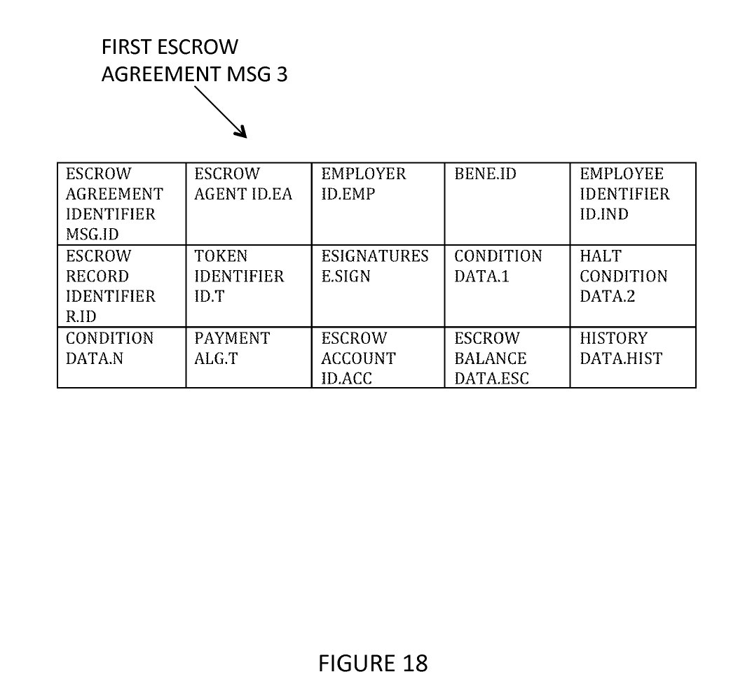

Referring now to FIG. 18, FIG. 18 is a schematic representation of the state of the first exemplary escrow document MSG 3 in a condition of memorializing an escrow employment contract that was formed by the offer of the escrow agreement with specified conditions DATA.1-DATA.N and as accepted by the recruiter. The first exemplary escrow document MSG 3 includes an identifier ID.MSG of the that uniquely identifies the first exemplary escrow document MSG 3 to the escrow system 2 and other systems 6, 8, 10 & 12 of the network 2. The first escrow agreement MSG 3 further includes the escrow agent identifier ID.EA, the employer ID.EMP, at least one beneficiary identifier BENE.ID that may be associated with the recruiter and/or the recruiter system 8, and an employee identifier ID.IND that identifies an individual who was referred by the recruiter to the employer and was hired by the employer within the scope of the escrow agreement MSG 3. The first escrow document MSG 3 further optionally includes (a.) an escrow record identifier R.ID that references an escrow record E.REC.1-E.REC.N that includes information relevant to the first exemplary escrow document MSG 3; and (b.) a token identifier ID.T that references an escrow record E.REC.1-E.REC.N that includes information relevant to the first exemplary escrow document MSG 3.

The first escrow document MSG 3 may further optionally include one or more electronic signatures of as issued by the escrow system 2, the employer system 6, and/or the recruiter system 8 wherein the electronic signatures are applicable to transform the first escrow agreement MSG 3 into a legally binding contract. The first escrow document MSG 3 may still further include the first condition DATA.1, a halt condition DATA.2, and additional conditions DATA.N. The halt condition DATA.2 may explicate (a.) under what conditions and terms the escrow system 2 is to halt escrow deposit payments to the recruiter or the recruiter system 8, as well as (b.) under what conditions and terms the escrow system 2 is to resume escrow deposit payments to the recruiter or the recruiter system 8 after a period of non-issuance of escrow deposit portion payments.

It is understood that the conditions DATA.1-DATA.N may be viewed in text format and/or graphic by the recruiter via the recruiter system 8, by the employer via the employer system 6, and by the escrow agent via the escrow system 2.

The first escrow document MSG 3 may further include the payment algorithm ALG.T, the escrow account identifier ID.ACC, the escrow balance DATA.ESC and historical or audit information relevant to the escrow agreement in the history data field DATA.HIST.

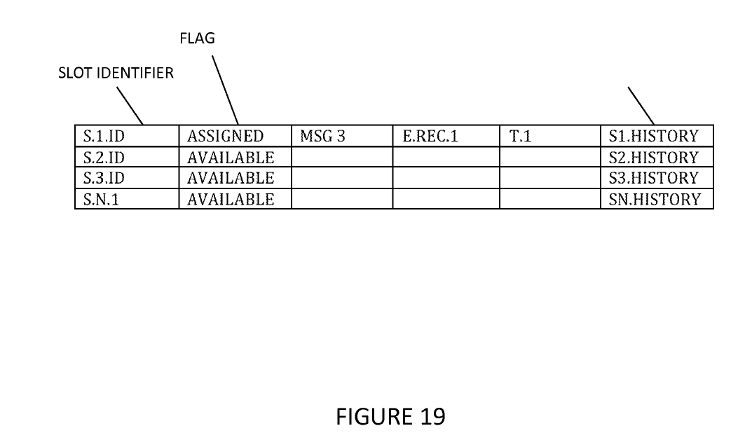

Referring now to FIG. 19, FIG. 19 is a schematic representation of a plurality of slots S.1-S.N wherein each slot S.1-S.N is represented by a row of the table of FIG. 19. Each slot record S.1-S.N includes a unique slot identifier S.1.1D-S.N.ID that uniquely identifies each slot S.1-S.N to the escrow system 2, the employer system 6, the recruiter and other systems 10 & 12 of the network 4. Each slot S.1-S.N further includes a dedicated availability flag that indicates to the systems 2, 6, 8 10 & 12 whether the slot S.1-S.N comprising the flag is assigned to an escrow process or is available for assignment to an escrow process. Each slot further comprises a separate history data S1.HISTORY-SN.HISTORY that includes data relevant to the previous use of the comprising slot S.1-S.N.

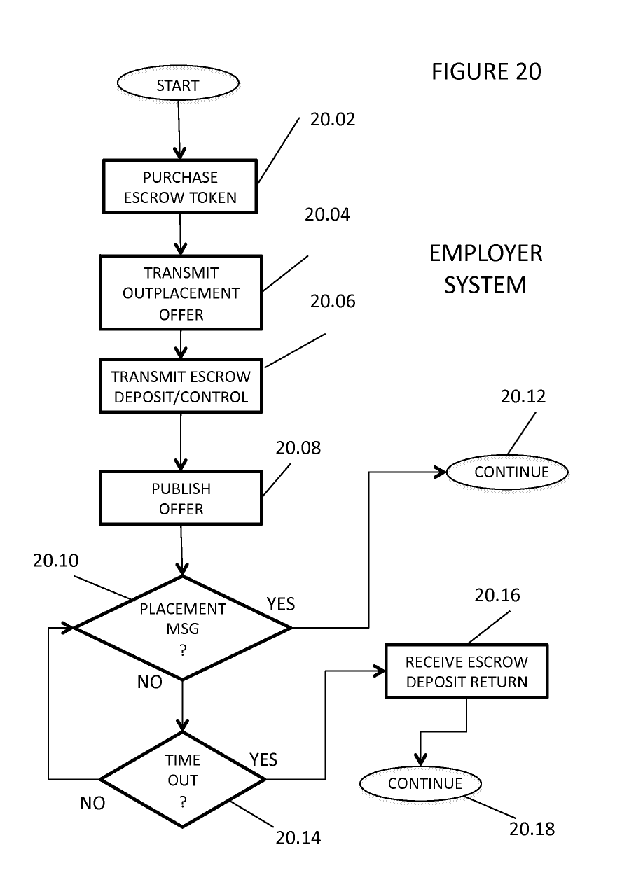

Referring now to FIG. 20, FIG. 20 presents a flowchart of other additional aspects of the invented method in application in an outplacement escrow deposit payment process. In step 2.02 the employer purchases an escrow token T.1-T.N via the employer system 6 from the escrow system 2. In step 20.04 the employer transmits an outplacement condition or conditions in an outplacement offer to the escrow system, wherein a condition is specified that an outplacement escrow will be earned in return for finding employment outside of the employer's staff or work force for an identified individual. The outplacement conditions of step 20.04 may include a deadline after which the offer is withdrawn

An escrow deposit, or control of an escrow deposit secured by the financial server 12, is sent by electronic message from the employer system 6 and to the escrow system 2 in step 20.06. The employer may optionally in step 20.08 publish the offer to deliver, or have delivered, the escrow deposit for meeting the conditions transmitted in step 20.06.

The employer system 6 determines in step 20.10 whether an outplacement message has been received from the escrow system 2 wherein the outplacement message would document that the escrow system 2 has validated a successful employment placement of the individual identified in step 20.04 and further that the escrow deposit of step 20.06, or control thereof, has been delivered to another party, e.g., the recruiter.

The escrow system determines in step 20.14 whether the deadline of the outplacement offer has expired, and proceeds to request and regain the escrow deposit, or control thereof, in step 20.16. The escrow system 2 proceeds from step 20.16 to step 20.18 and to perform alternate computational operations.

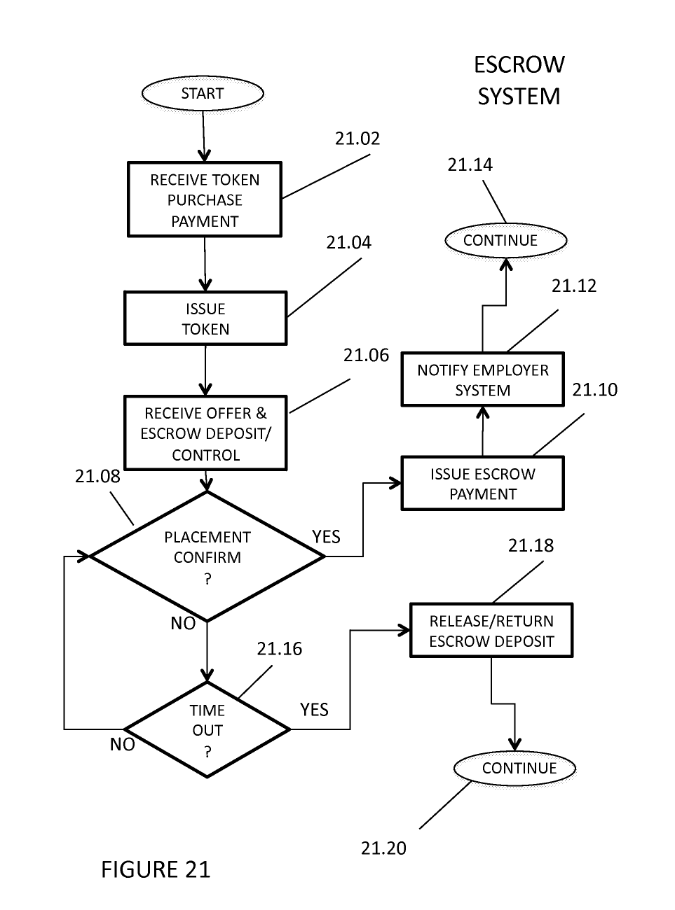

Referring now to FIG. 21, FIG. 21 presents a flowchart of other additional aspects of the invented method in application in an outplacement escrow process that may be performed by the escrow system 2 in concert with the escrow agent. In step 21.02 the escrow system 2 receives purchase request with payment for an assignment of one or more escrow tokens T.1-T.N or optionally slots S.1-S.N. In step 21.04 the escrow system issues or assigns the first token T.1 to the employer system 6, and the escrow system 2 receives the outplacement offer of step 20.06 either the outplacement escrow deposit or control thereof in an electronic message from the employer system 2.

The escrow agent and/or the escrow system 2 determine in step 21.08 whether a party, e.g., the recruiter or the recruiter system 8, has transmitted a message comprising proof that the individual identified in the outplacement offer of step 20.04 has received an employment condition satisfying the conditions of the outplacement offer of step 20.06. When the escrow agent and/or the escrow system 2 determine in step 21.08 that a party has transmitted am outplacement confirmation comprising proof that the individual identified in the outplacement offer of step 20.04 has received an employment condition satisfying the conditions of the outplacement offer of step 20.06, the escrow system 2 issues a transfer of the escrow deposit to the party identified in the outplacement confirmation in step 21.10 and reports the successful outplacement to the employer system 2 in step 2.12. The escrow system 2 proceeds on from step 21.12 to perform alternate computational operations in step 21.14.

The escrow system 2 determines in step 21.16 if the conditions of the outplacement offer have not been met prior to the deadline imposed or communicated by the employer system 6. When the escrow system 2 determines in step 21.16 that the conditions of the outplacement offer have not been met prior to the deadline imposed or communicated by the employer system, the escrow system proceeds on to step 21.18 and the return the escrow deposit, or control of the escrow deposit, back to the employer or the employer system 2. The escrow system 2 proceeds on from step 21.18 to perform alternate computational operations in step 21.20.

It is understood that any, each and all electronic data transmissions, messaging and notifications disclosed herein may be accomplished between or among the systems 2, 6, 8, 10 & 12 and via the network 4, to include email messaging, instant messaging, small message services, digital texting, ad/or other suitable electronic messaging means and modes known in the art, e.g. by messaging via the TWITTER™ messaging service.

It is further understood that any transfer of monetary values as disclosed herein may be accomplished by either electronic messaging or transmission of hard copy financial instrument, to include automated clearing house transfer, wire transfer, electronic funds transfer, bank check, personal check, cashiers check, postal money order and money order.

It is still further understood that each disclosure of an exemplary electronic record T.1, E.REC.1, MSG 3 & S.1 is not meant to be limiting but is meant to apply to electronic messages of similar and corresponding structure and content, e.g., tokens T.2-T.N, escrow records E.REC.2-E.REC.N, escrow agreements MSG 3.2-MSG 3.N & S.2-S.N.

One skilled in the art will recognize that the foregoing examples are not to be taken in a limiting sense and are simply illustrative of at least some of the aspects of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. The method of claim 31, wherein the balloon payment is a first payment of a series of escrow portion payments.

33. (canceled)

35. (canceled)

36. (canceled)

37. (canceled)

38. (canceled)

39. (canceled)

40. An information technology system for establishing and performing an escrow agreement, the system including:
an employer interface adapted to enable an employer to populate an invitation, the invitation soliciting recruiter candidate proposals and indicating an escrow payment condition for a candidate placement reward;
a processor responsive to the interface and adapted to communicate the invitation via an electronics communications network (“the network”); and
a network interface module, the network interface module bidirectionally communicatively coupled with the processor and the network, and wherein the network interface enables the system to both communicate the invitation via the network and receive an acceptance of the escrow payment condition by a recruiter via the network.

41. The system of claim 40, wherein the information technology system is further enabled the invitation to be cancelled prior to a formation of an escrow agreement.

42. The system of claim 40, wherein the information technology system is further enabled to communicate a rejection of the invitation to the employer.

43. The system of claim 40, wherein the information technology system further enables the employer to modify, add or delete a term or condition of the invitation.

44. The system of claim 40, wherein the information technology system further enables the employer to generate a second invitation for a second candidate placement reward, wherein the second invitation includes at least one term or condition of the earlier generated invitation.

45. The system of claim 40, wherein the information technology system enables a single and complete escrow payment to the recruiter under the terms of the invitation.

46. The system of claim 40, wherein the employer interface is further adapted to transmit an alert regarding the invitation to a network address of the network to the recruiter.

47. The system of claim 40, wherein the escrow payment condition obligates the employer to deliver an escrow deposit to an escrow agent upon a starting date of an employment of an employment candidate initially identified to the employer by the recruiter.

48. The system of claim 47, wherein an escrow deposit is calculated at least partially on the basis of an element of a compensation amount offered to the individual.

49. The system of claim 47, wherein the employer interface is further adapted to enable a transfer of the escrow deposit to an escrow account by electronic funds transfer via the network, wherein the escrow account is under the control of the escrow agent.

50. The system of claim 47, wherein the escrow payment condition stipulates that the escrow agent shall transfer the escrow deposit to the recruiter in periodic fractional payments over a specified time period while the escrow payment condition is satisfied.

51. The system of claim 50, wherein the escrow payment condition stipulates that the fractional payments will cease upon separation of the candidate from employment by the employer.

52. The system of claim 50, wherein the escrow payment condition stipulates that any remaining funds balance of the escrow account shall be delivered to the employer upon termination of the candidate when the candidate was a subject of the employment contract.

53. The system of claim 50, wherein the fractional payments are substantively equivalent in denomination.

54. The system of claim 50 wherein at least one fractional payment is larger in denomination than any other fractional payment.

55. The system of claim 54, wherein a first fractional payment is larger that any other fractional payment.

56. The system of claim 54, wherein a final fractional payment is larger that any other fractional payment.

57. The system of claim 40, wherein the employer interface is further adapted to enable acquisition of an escrow token, wherein the escrow token is applicable to initiate an escrow account associable with the invitation.

58. The system of claim 57, wherein the employer interface is further adapted to enable initiation of an escrow account by communicating an assignment of the escrow token to the escrow account initiation.

59. The system of claim 40, wherein the employer interface is further adapted to enable authoring an invitation that specifies a deadline requirement of a formation of an employment contract.

60. The system of claim 40, wherein the employer interface is further adapted to enable authoring an invitation that specifies a denomination of an escrow payment deposit.

61. The system of claim 40, wherein the employer interface is further adapted to enable authoring an invitation that specifies a time period over which an escrow payment is paid out while the escrow payment condition is satisfied.

62. The system of claim 40, further comprising:
a recruiter interface adapted to enable the recruiter to receive and render the invitation from the employer;
a second processor responsive to the recruiter interface and adapted to receive the invitation via the network; and
a second network interface module, the second network interface module bidirectionally communicatively coupled with the second processor and the network, and wherein the second network interface enables the system to both receive the invitation via the network and issue an acceptance of the escrow payment condition by the recruiter via the network.

63. The system of claim 62, wherein the recruiter interface is further adapted to enable an authoring of an acceptance of the invitation.

64. The system of claim 40, wherein the system further comprises:
an escrow agent interface, the escrow agent interface enabling an escrow agent to execute an escrow agreement;
a third processor responsive to the escrow agent interface and adapted to communicate with the employer interface and the recruiter interface via the network; and
a third network interface module, the second network interface module bidirectionally communicatively coupled with the third processor and the network, and wherein the third network interface enables the third processor to communicate with the processor and the second processor via the network.

65. The system of claim 64, wherein the escrow agent interface further enables the escrow agent to electronically transfer payments from an escrow account to a recruiter account.

66. An information technology system for establishing and performing an escrow agreement, the system including:
a recruiter interface adapted to enable a recruiter to generate and communicate a proposal, the proposal offering to provide employment candidates and indicating an escrow payment condition for a candidate placement reward;
a processor responsive to the interface and adapted to communicate the proposal via an electronics communications network (“the network”); and
a network interface module, the network interface module bidirectionally communicatively coupled with the processor and the network, and wherein the network interface enables the system to both communicate the proposal via the network and receive an acceptance of the escrow payment condition by an employer via the network.

67. The system of claim 40 further comprising:
means adapted to assign a plurality of slots to the employer, each slot having an expiration date;
means adapted to enable the employer to assign individual employment escrows to each slot; and
means adapted to enable the employer to replace an earlier assignment of a first employment position to a first slot with a succeeding assignment of a second employment position.

68. An information technology system for establishing and performing an escrow agreement, the system including:
a contracting interface adapted to enable a contracting party to populate an invitation, the invitation soliciting personal performance proposals and indicating an escrow payment condition as compensation to a broker for identifying a contractor with whom the contracting party forms a personal performance contract; and
a processor responsive to the interface and adapted to communicate the invitation via an electronics communications network (“the network”); and
a network interface module, the network interface module bidirectionally communicatively coupled with the processor and the network, and wherein the network interface enables the system to both communicate the invitation via the network and receive an acceptance of the escrow payment condition by the broker via the network.

69. (canceled)

70. (canceled)
